(19) United States
(12) Patent Application Publication
(10) Pub. No.: US 2011/0250455 A1
(43) Pub. Date: Oct. 13, 2011

(54) MECHANICALLY PLATED PELLETS AND METHOD OF MANUFACTURE

(76) Inventors: Daniel J. Gordon, Homer, IL (US); Steven C. Hansen, Urbana, IL (US); Trggvi I. Emilsson, Champaign, IL (US); Timothy R. Brumleve, Urbana, IL (US)

(21) Appl. No.: 13/084,414

(22) Filed: Apr. 11, 2011

Related U.S. Application Data
(60) Provisional application No. 61/322,691, filed on Apr. 9, 2010.

(51) Int. Cl. B32B 5/16; B05D 7/02; B05D 7/14; B05D 5/00; B05D 7/00

(52) U.S. Cl. 428/407; 427/346; 427/347; 427/212; 427/215; 427/216; 427/222; 428/403

(57) ABSTRACT

Mechanical plating provides a new technique of manufacturing of certain materials containing multiple elements, including amalgams, and novel pellets containing multiple materials. Some embodiments provide new and versatile materials for dosing mercury, metals or other inorganic compounds into lamps. Some embodiments include materials comprising layers of metals or compounds built up on a substrate. One embodiment is a layer of zinc amalgam applied to a glass sphere. Also disclosed is an improved method of manufacture for such particles that will speed production, increase yields, lower costs and reduce exposure to mercury in the workplace.

### CROSS-REFERENCE TO RELATED APPLICATION

This application claims priority under 35 U.S.C. §119(e) from U.S. Provisional Patent Application Ser. No. 61/322,691 filed Apr. 9, 2010, the entirety of which is hereby incorporated by reference herein.

### BACKGROUND

In various industries and technologies, there exists a need to provide precise and small amounts of various materials. For example, in the lighting industry it is necessary to deliver small amounts of mercury into the discharge vessel of a fluorescent lamp. Mercury may be introduced into a discharge lamp in the form of solid amalgam particles. Particles that are used to provide a small amount of a material may be referred to as pellets. A known technique for manufacturing and using amalgam pellets for providing a dose of mercury into a discharge lamp is the melt-based (drop tower) technique described at U.S. Pat. No. 4,419,303, “Method for producing large diameter high purity sodium amalgam particles,” to Anderson. FIG. 1A shows a prior art Zn—Hg pellet 100a produced by the melt-based approach. Pellet 100a includes zinc (Zn) 102, mercury (Hg) 104, and Zn—Hg in the gamma (γ) phase (Zn₃Hg) 106. The melt-based technique has been applied previously to quench a molten mixture of mercury and at least one other metal from a molten state, e.g., by passing the molten mixture through a cooled environment, in a process referred to as a particulation process. The melt-based approach involves processing a mixture containing mercury at a high temperature, e.g., about 400° C. The high temperatures involved in the manufacture of such materials creates a situation where mercury boils off the pellet as it freezes and where mercury vapor can escape from the high temperature containment vessels employed. The pellets that result from the atomizing process are typically rough and slightly elliptical. The melt-based approach is typically associated with relatively high cost, relative difficulty in manufacturing and relatively high risk of mercury exposure.

A need exists to remedy some or all of these deficiencies in the production of amalgam pellets for fluorescent lamps. In addition, it would be highly desirable to provide an amalgam pellet that is designed a priori rather than being completely limited by the physical constraints of the materials and processes available in the prior art. More generally, a need exists for improved techniques for delivering a controlled amount (i.e., a precise dose) of various materials in diverse industries.

### SUMMARY

In some embodiments, a method of coating a substrate with a layer of material includes providing a substrate in a container, providing impact media in the container, providing multiple solid particles comprising a first material in the container, providing a liquid comprising a second material in the container, and mechanically moving the container to thereby effect the mechanical plating of a layer of material comprising the first and second elements onto the surface of the substrate. The impact media may be the same as the substrate (plated) media or different. The second material may be mercury, and the first material may include one or more of the following materials: zinc, tin, bismuth, iron, scandium, yttrium, indium, lead, gallium, cadmium, silver, copper, gold, aluminum, thallium, titanium, zirconium, manganese, nickel, chromium, cobalt, molybdenum, tungsten, alkali metals, alkaline earth metals, and a lanthanide with atomic number between 57 and 71.

In some embodiments, a method of making amalgam pellets includes providing multiple pelletized substrates in a container, providing multiple particles comprising a metallic element in the container, providing liquid mercury in the container, and mechanically moving the container to effect the formation to a layer of material comprising an amalgam or composite of the metallic element on the surface of the substrates.

In some embodiments, a method of making pellets is provided. A substrate is provided to form the core of the pellet. An amalgam or composite layer is mechanically plated and encapsulates the core to form the outer surface of the pellet. The encapsulating layer may include a selected mercury content that may vary between 0.5 weight percent and 90 weight percent. The core may include one or more of the following materials: glass, ceramic, metal, alloy, amalgam, cermet, plastic, and an intermetallic compound. The amalgam may include one or more of the following: zinc, tin, bismuth, indium, nickel, manganese, titanium, copper, iron, scandium, yttrium, and the lanthanides from atomic number 57 to atomic number 71.

In some embodiments, a pellet includes an inner core and a mechanically plated amalgam or composite material layer encapsulating the core to form the outer surface of the pellet.

In some embodiments, a pellet includes an outer layer of zinc amalgam that is substantially all in the Zn₃Hg phase and is formed at substantially room temperature.

In some embodiments, a pellet includes a core and a mechanically plated layer encapsulating the core and forming the outer surface of the pellet. The mechanically plated layer includes at least one of the following: zinc, tin, bismuth, iron, scandium, yttrium, indium, lead, gallium, cadmium, silver, copper, gold, aluminum, thallium, titanium, zirconium, manganese, nickel, chromium, cobalt, molybdenum, tungsten, alkali metals, alkaline earth metals, and a lanthanide with atomic number between 57 and 71.

In some embodiments, a material for use in mechanically plating substrates with an amalgam layer includes a powder of one or more metals dispersed in liquid mercury.

In some embodiments, a pellet includes an inner core and a mechanically plated layer encapsulating the core. The mechanically plated layer may include mercury and another material in a metastable, non-equilibrium state. The encapsulating layer may include one or more of zinc, tin, and bismuth.

### BRIEF DESCRIPTION OF THE DRAWINGS

The following will be apparent from elements of the figures, which are provided for illustrative purposes and are not necessarily to scale.

FIG. 1A is a schematic representation of the microstructure of a Zn—Hg pellet produced by the known melt-based method.

FIG. 1B is a schematic representation of a known amalgam pellet.

FIG. 2 is a schematic representation a pellet including a promoter layer between the core and the Zn₃Hg phase in accordance with some embodiments.

FIG. 3 is the binary Zn—Hg phase diagram.

FIG. 4 is a diagram illustrating mercury weight loss from mechanically plated Zn—Hg (10 mg) and from melt-based Zn—Hg.

FIG. 5 is an x-ray diffraction spectrum of melt-based Zn—Hg containing 50 weight percent Hg, with zinc solid solution and Zn₃Hg present at room temperature.

FIG. 6 is an x-ray diffraction spectrum of mechanically plated Zn—Hg comprising predominantly Zn₃Hg.

FIG. 7 is a schematic representation of a pellet with a non-spherical amalgam core in accordance with some embodiments.

FIG. 8 is a schematic representation of a getter integrated into a mechanically plated amalgam coating, with the getter in physical contact with the amalgam coating.

FIG. 9 is a schematic representation of a mercury dispenser and getter that are physically separated from each other.

FIG. 10 is a schematic representation of a regulating amalgam cover over a zinc amalgam.

FIG. 11 is an x-ray diffraction spectrum of Zn—Ni—Mn—Hg amalgam showing a binary Mn—Ni phase.

FIG. 12 is a schematic representation of a Zn—Hg core that is used to build up a larger Zn—Hg pellet in accordance with some embodiments.

FIG. 13 is a diagram of a fluorescent lamp containing a mechanically plated amalgam in accordance with some embodiments.

FIG. 14 is a plot of weight vs. time for mercury release from Bi—Hg (50 wt % Hg) by thermogravimetric analysis (TGA).

FIG. 15 is the binary Bi—Hg phase diagram.

FIGS. 16A-B are schematic representations of pellets made with glass powder added to premix, with identical diameters and varying amounts of mercury.

FIGS. 17A-B are schematic representations of pellets made with glass powder added to premix, with varying diameters and identical amounts of mercury.

FIG. 18 is a schematic representation of a substrate having a coating applied by mechanical plating, with the coating itself including pre-coated particles.

FIGS. 19A-B are schematic representations of containers including substrates for mechanical plating in accordance with some embodiments.

### DETAILED DESCRIPTION

Embodiments of the present disclosure remedy many of the shortcomings involved in the production and manufacture of low pressure and high pressure discharge lamps. A new method to coat spheres with an amalgam bypasses many of the drawbacks of the prior art method.

Various embodiments provide a general purpose, high throughput production system capable of encapsulating materials, without the need for high temperature systems, applicable to a wide range of materials. In addition, mercury emissions are reduced, and the shape of amalgam pellets is improved, e.g., with a shape that is closer to perfectly spherical than has been possible with previous techniques. The cost of producing amalgam pellets in accordance with various embodiments is typically less than that of high temperature melt-based approaches. A wide variety of substrates are usable in the improved process. The production equipment of an improved process is more rugged and durable than the prior art method and is less critical (less demanding) in terms of operator skill.

Various embodiments do not rely on the use of molten amalgams but rather use mechanical and optionally electrochemical means to plate an amalgam onto a preformed base. In some embodiments, a zinc amalgam is mechanically plated onto a solid spherical (or roughly spherical) particle. By means of mechanical force, a mixture of liquid mercury and fine zinc dust reacts with and forms nearly pure Zn₃Hg (gamma, or γ) phase. When the mechanical action is caused by spherical objects impinging on one another, the result is a gradual build-up of gamma phase on the spherical objects. The gradual enlargement of Zn—Hg amalgam may be controlled by process parameters and may produce nearly spherical amalgam pellets that are closer to spherical than has been possible with conventional techniques.

Various embodiments allow unlimited combinations of diameter and Hg content by weight. Amalgam diameter and amalgam composition may vary according to what is appropriate for a particular application. For example, mercury content may vary from 0 to 95 wt %. Prior art Zn—Hg pellets produced in accordance with U.S. Pat. No. 5,882,237 to Sarver et al. have been limited in diameter and composition based on practical considerations. Mechanical plating in accordance with various embodiments of the present disclosure enables production of pellets with a wider range of composition and wider range of diameters. Additionally, mechanical plating enables materials that were inherently sticky when made by the melt-based method to be free flowing when made in accordance with various embodiments.

Mechanical Plating with Premix

In some embodiments, a material referred to as “premix” is used in mechanical plating to create amalgam spheres with homogeneous composition. Premix is an intimate dispersion of metal (or alloy) dust and mercury. The metal or alloy dust may have a particle size less than 500 preferably less than 200 μm, even more preferably less than 50 and most preferably less than 10 μm. The dust particles may be substantially uniform in size. In some embodiments, the dust particles include particles in at least two or three different sizes. The dust particles may be spherical. Premix acts like a solid but pours like a viscous liquid. Premix may be composed of virtually any metal dust (if fine enough) and mercury. Intermetallic compounds may form in the premix if the shaking (or other mechanical agitation or movement) that is employed during formation of premix (described below) is strong enough. X-ray diffraction confirms that liquid mercury is present in Zn—Hg premix and that a small amount of Zn₃Hg may form. The average composition is closer to the target composition than with prior art material. Zinc dust size (the size of a dust particle along a largest dimension) may vary from 1-100 μm, but is preferably in the range 3-30 μM.

Zn—Hg premix may vary in composition from 0 wt % Hg to 95 wt % Hg, preferably in the range of 40-75 wt % Hg, and most preferably about 50 wt % Hg. Other types of premix can be made. For instance, tin and bismuth premixes were made with 50 wt % Hg each. The premix may consist essentially of bismuth and mercury. These were used to plate solid spheres as is explained in the examples below. Other plateable metals made be used to form premix. A wide range of materials may be added to premix, including, but not limited to, alloys, amalgams, glasses, ceramics, oxides, carbides, nitrides, silicides, getters, etc.

Formation of Premix

Zn—Hg premix may be made by adding equal weights of zinc dust and mercury together in a container. The zinc dust and mercury are sealed and shaken (or otherwise mechanically agitated or moved) for a period of time that may be 5-10 minutes. The resulting mixture is a very fine dispersion of zinc and mercury and may contain a small amount of intermetallic γ (Zn₃Hg) phase.

Other elements may be incorporated into the premix and coated on the glass bead. For instance, a Zn—Ti alloy containing approximately 2.5 weight percent titanium was milled and ground to a fine powder and added to Zn—Hg premix. A Zn—Ti—Hg amalgam was formed using the Zn—Ti powder and the Zn—Hg premix. Additions to premix are preferably powders of metals, alloys or other solid materials such as glasses or ceramics.

The underlying substrate that is to be plated may be glass, metal, ceramic, cermet, vitreous solid, plastic, semiconductor, or a composite of these materials. It may include an alloy, such as Zn—Hg or stainless steel, or a single phase material such as Zn. The substrate may be inert to mercury or reactive with mercury and may be single crystal or polycrystalline. The hardness of the substrate may vary. For many applications, the preferred shape for the underlying substrate is a sphere, although the substrate may deviate slightly from perfectly spherical. The substrate may have a porous or hollow interior and exterior and may be itself constructed of several layers of the abovementioned materials. The substrate that forms the core of the pellet may have a largest dimension between 50 μm and 5000 μm.

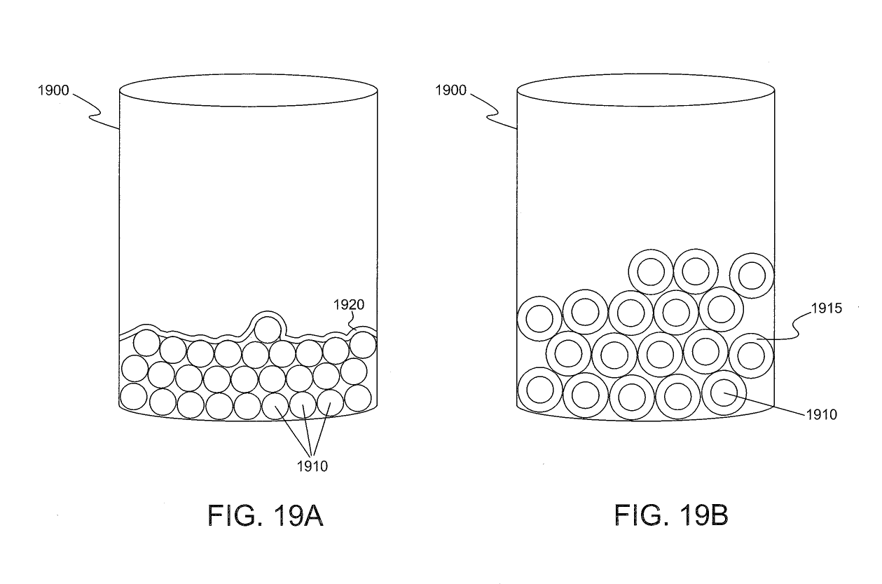

In some embodiments, a solid substrate (e.g., glass bead) is coated with zinc amalgam by using a premix of zinc dust and pure mercury. Referring to FIG. 19A, a container 1900 is filled with multiple glass beads 1910, e.g., until the container is about 1/10 to ½ full (preferably about ⅓ to ¼ full). The container may have a cylindrical or hexagonal cross section, for example, and it may be lined with wire mesh in some embodiments. The container may have longitudinal ridges. The aspect ratio (e.g., height:diameter ratio of a cylindrical container) of the container may vary between 1:1 and 10:1, with a preferred aspect ratio between 3:1 and 4:1. The container may have a hollow cube shape, or it may be hollow and cylindrical with rounded ends, or it may be any other closed container. The substrates may vary in size and shape. A small amount of Zn—Hg premix 1920 is added to the container. The container is shaken in some embodiments, e.g., for about 30-40 seconds. In some embodiments, shaking may be performed for 10-300 seconds. Due to the shaking, the zinc dust and mercury are deposited onto the glass beads 1910 to form a tightly adherent coating 1915, as shown in FIG. 19B. The container may be shaken until all or substantially all of the premix has been consumed (applied to the beads). Instead of shaking, the container may be rotated, vibrated, and/or moved to effect mechanical plating. For example, the container may be moved in a conoidal pattern, a rotational pattern, translational pattern, a vibrational pattern, or any other motion (including a combination of the above motion patterns) that provides plating of amalgam to the substrate. The speed associated with the motion may be constant, variable, or include an interrupted motion. An additional small amount of zinc premix may be added, the container may be shaken again, and such addition of premix and shaking may be repeated.

The pellets are thus coated with zinc and mercury. These are transformed into Zn₃Hg by the mechanical plating process. The mechanical plating may be carried out at or near room temperature, e.g., 30±30° C. for Zn—Hg. Other materials may vary somewhat in their upper, lower and optimum temperature ranges for mechanical plating.

Multiple tests were performed using the premix method. The target size was 10 mg Zn—Hg (5 mg Hg), and an outside diameter of the final product was about 1500 μm. The glass bead substrate used to create this size was approximately 1050 μm and weighed about 1.5 mg. Thus, the final weight of the pellets is about 11.5 mg.

Mechanical Plating without Premix

In some embodiments, mechanical plating is effected without the use of a premix. Pure zinc and pure mercury can be used to create a mechanically plated particle. To achieve a homogeneous composition of the plated objects, it is useful to have Zn—Hg pellets present in the mixture. The Zn—Hg particles help to coat the glass spheres uniformly. One method of obtaining a uniform coating appears to be the use of a very large surface area provided by Zn—Hg pellets, which creates numerous contact points for the Zn—Hg to coat the glass spheres. A container is filled with multiple glass beads. A small amount of Zn dust is added to the container. A small amount of Hg (which is liquid, because the process is carried out at substantially room temperature) is also added to the container. Zn—Hg pellets may be optionally added to the container to help with uniform coating as described above. The container is shaken (or otherwise mechanically agitated or moved), e.g., for 60-150 seconds. More Zn dust and Hg may be added to the container. The container may be shaken again. The coating on the glass beads may be built up by repeatedly adding more Zn dust and Hg and shaking, until the pellets reach a desired diameter.

Glass spheres may be primed with a thin layer of zinc amalgam by shaking them vigorously with the proper amount of mercury and zinc powder. The thickness of the initial layer may be increased by further shaking with more of the precursor metals, or by electrochemical means. Thus, electrochemical plating may be used in conjunction with mechanical plating. The preparation of pre-mixed powders of zinc and mercury (premix) facilitates maintenance of accurate Zn/Hg ratios.

Mechanical plating at room temperature occurs by cold welding small metal particles to a solid core. Zn—Hg amalgam wets glass and easily coats it with a microscopic layer. Glass beads or other solid “cores” act as hammers to pound the metal onto each other. In contrast to other mechanical plating systems, no water, promoters, surfactants or anti-foaming agents are needed.

A thin layer of Zn—Hg may be used to wet a solid sphere and be the “promoter” of a mechanically plated sphere. If Zn and other metal dusts are mixed together, the Zn and Hg generally wet the solid and start the mechanical plating process.

In the case of Zn—Hg, mechanical plating actually creates the equilibrium phase Zn₃Hg. In the case of Sn—Hg, mechanical plating creates an equilibrium phase and also an unidentified phase with very high mercury content, up to 80 wt % Hg.

The phases created by mechanical plating may be stable or metastable phases. Stable phases may be comprised of stoichiometric compounds, solid solutions, ordered, magnetic and other compounds.

A preferred list of components includes powders of the following metals and compounds: zinc, tin, bismuth, nickel, titanium, manganese, iron, indium, copper, silver, zirconium, palladium, borides, carbides, halides, aluminides, silicides, oxides, and hydrides.

Some embodiments provide a pure zinc coating on glass spheres. Pottberg and Clayton (U.S. Pat. No. 2,723,204) showed how to dry coat Zn on ferrous materials (e.g., iron and steel), but they did not coat glass. Zinc, tin, bismuth, copper and nickel have been successfully coated onto glass spheres in accordance with various embodiments. Other soft and semi-soft metals may also be used as a promoter.

Zinc dust and mercury were shaken together in the prior art (U.S. Pat. No. 4,578,109 to Miyazaki et al.) by a method known as dry amalgamation. The preferred size of zinc dust in the prior art was between 75 and 500 microns. In embodiments of the present disclosure, a 5-10 micron particle size is preferred. This creates a material with a finer structure that creates an improved Zn—Hg amalgam. Starting materials may be in a variety of shapes and sizes. Zn dust or other metal dusts may range from 1 μm to 100 μm, although 3-30 μm is preferred.

The starting material may have a single particle size, a bimodal distribution or a multimodal distribution. Zinc dust and other metal dust may be spherical, irregularly shaped or a combination thereof. Particles smaller than about 3 μm tend to have a high surface area/volume ratio, and as a consequence, a large oxide content. A high oxide content by itself is not objectionable but may be associated with the formation of other compounds that are problematic because they contain water or OH groups. Water and OH are detrimental to the operation of a lamp.

The prior art depends on surface amalgamation. The present invention relies on bulk amalgam formation of Zn₃Hg or γ phase. The composition of the dry amalgam cited in the above patents was not specified, but the final concentration of mercury in the zinc powder was generally less than 10 wt % and typically about 2-4 wt %. This range is below the range of the present invention.

U.S. Pat. No. 4,514,093 to Coch discloses introducing the pulverent metal into a mechanical plating operation as a mixture of water and zinc dust, for example. The zinc dust quickly settles to the bottom of the plating container and is not suspended in the mixture. U.S. Pat. No. 5,762,942 to Rochester introduces the pulverent metal as a slurry. The slurry assists in the formation of the mechanically plated layer. Various embodiments of the present disclosure add the premixed metal and mercury as a viscous powder whose behavior is fluid-like.

A premix may be made of materials other than Zn dust and Hg, such as Bi dust and Hg. A premix including Zn and Hg may also include one or more of the following: getter, compound, grain refining agent, promoter, metal, alloy, and amalgam. The material may contain a promoter additive that creates a promoter layer. The promoter layer may include a wide variety of metals, alloys or amalgams. For instance, the promoter may include an amalgam of Na—Hg coated onto a solid substrate, an amalgam of alkali metals (Li, Na, K, Rb, Cs), Zn—Hg, Zn, Cu, Bi, Sn, In, and other metals may be used as promoters.

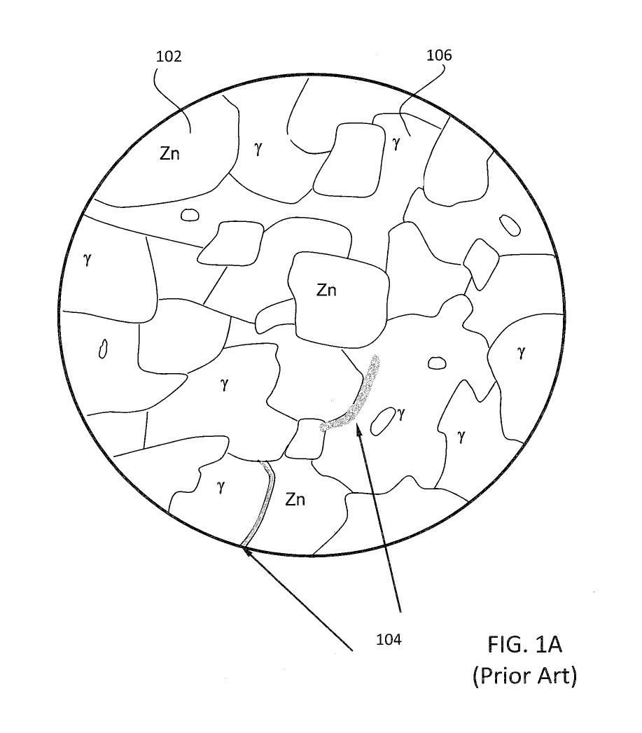

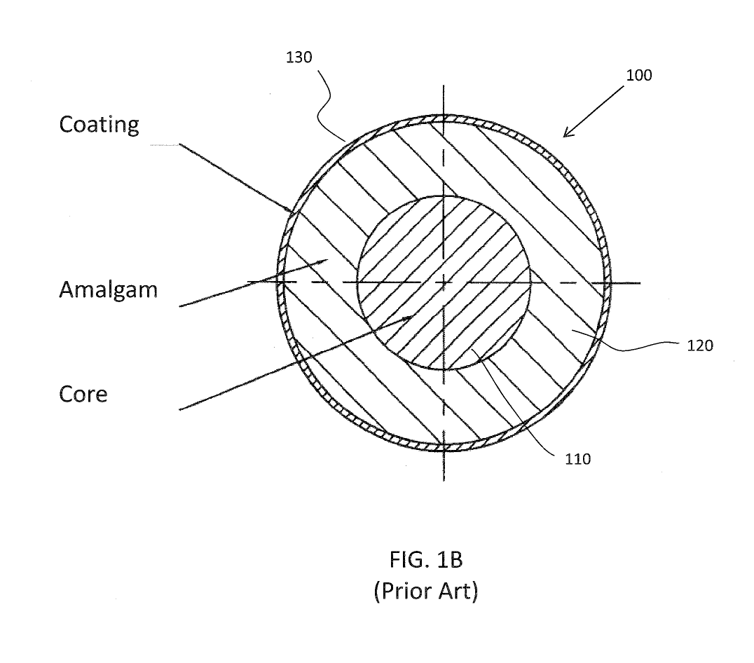

Prior art techniques using the melt-based approach result in a solid Zn—Hg pellet (e.g., pellet 100a of FIG. 1A) that has been quenched from the molten state. Various embodiments of the present disclosure plate solid Zn—Hg onto a solid sphere (or nearly spherical object). In the prior art, there are two basic techniques of creating a mechanically plated layer: dry plating and wet plating. The wet plating technique uses water, promoters, surfactants, thickeners, acid, inhibitors, glass beads or other impact media to produce bright, and/or adherent coatings. The mechanical plating technique disclosed in various embodiments does not involve contact with water and avoids water contamination and large amounts of hazardous waste.

The prior art dry plating technique uses only metal powder and possibly other dry agents such as graphite, molybdenum disulfide, plastics and resins to create an adherent, bright coating.

Some embodiments differ from a wet plating method because there are no aqueous solutions or acid cleaners. Some embodiments differ from the dry method in the sense that the plating material is a dispersion of a solid and a liquid metal together. Some embodiments are similar to both because plating occurs at room temperature in air or in a protected environment. Multiple additions of plating metal are added to the container. The particles being plated may act as their own impact media. Other impact media, usually much larger, such as Teflon spheres, may also be added to impart an improved surface finish.

Mechanical plating in accordance with various embodiments produces a pellet that is not sticky and therefore does not need additional coating, unlike the pellet in the prior art of CN 10100848 and CN 2836231. Such a prior art pellet 100 is shown in FIG. 1A having a core 110, an amalgam layer 120, and an additional coating 130.

Mechanical Alloying

Mechanical plating can create alloys from single phase materials (e.g., zinc and mercury). In other words, zinc and mercury combine to form a new phase, namely, Zn₃Hg or γ phase. Various embodiments develop new phases such as Zn₃Hg and possibly other phases in the Zn—Hg system. Embodiments are not limited to compounds formed only between Zn and Hg, but can be applied to a wide variety of plateable metals.

U.S. Pat. No. 5,529,237 to Yashima discloses a process for mechanically alloying the coating materials with the substrate. Most embodiments do not rely on mechanical alloying with a substrate to form a tenacious bond.

Promoter Layer

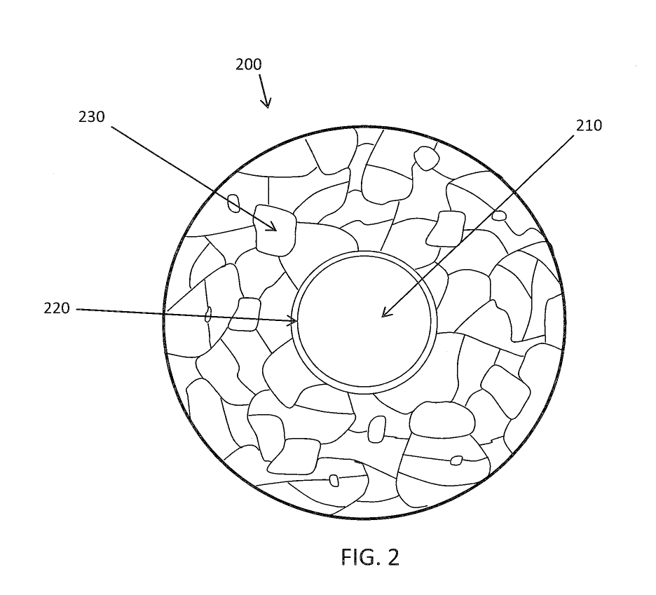

A promoter layer may be formed on the surface of the material being coated. In the prior art a promoter layer is sometimes prepared by wet or dry plating copper or tin, onto the articles to be plated. Additionally, it is possible to dry plate a promoter layer onto the solid core being used as a substrate for the amalgam coating. FIG. 2 is a schematic diagram of a pellet 200 having promoter layer 220 between a substrate 210 and a Zn₃Hg layer 230. The amalgam layer 230 may vary in thickness between 0.5 μM and 3000 μm in some embodiments. The promoter layer 220 may be zinc, zinc-mercury amalgam, sodium-mercury amalgam or other materials which can be mechanically plated onto the solid substrate 210.

Plating occurs as the solid and liquid phases combine on the surface of the impact media and form a new solid. It is believed that the zinc phase is smeared onto and firmly deposited by the force of the impact media, and fresh zinc metal is exposed at a very small scale. The clean zinc metal reacts almost instantaneously with mercury because they are in microscopic contact with each other. At the same time, the zinc-mercury amalgam created by the reaction is plated onto a solid substrate by the nearly simultaneous impact of another solid sphere.

Unlike in the prior art, the zinc-mercury mixture creates its own promoter by wetting glass, metal, ceramics, minerals, plastics and probably non-metals such as semiconductors, carbides, oxides, nitrides, etc. In this context, “wetting” refers to reduction of contact angle and full, continuous coating of the substrate surface, as opposed to wet processes involving water or solvents as in the prior art. As disclosed in U.S. Pat. No. 3,093,501 to Clayton et al., the use of finely powdered graphite or molybdenum disulfide mixed with Zn dust will coat glass surfaces.

Various embodiments allow for a promoter layer of Na—Hg. Shaking bare glass beads with Na—Hg amalgam may deposit a thin layer of sodium and mercury. Mechanical plating may be accomplished with or without promoter layers. Promoter layers may include a single metal, an alloy, or a mercury-containing amalgam such as Zn—Hg with mercury content between 2.5 wt % Hg to 90 wt % Hg. Various embodiments allow for a premix with a promoter intimately mixed in the metal or alloy powder.

Room Temperature

In the prior art melt-based approach, the components of the amalgam or alloy are mixed and melted into a homogeneous mixture at high temperatures. In various embodiments of the present disclosure, components do not need to be heated. In the case of coating a substrate with Zn—Hg, various methods of applying a coating may be used. Pure liquid mercury and pure zinc dust may create a Zn—Hg coating. Alternatively, a finely divided mixture of liquid mercury and Zn dust (premix) may be used. A powdered Zn₃Hg alloy may be used.

Phases

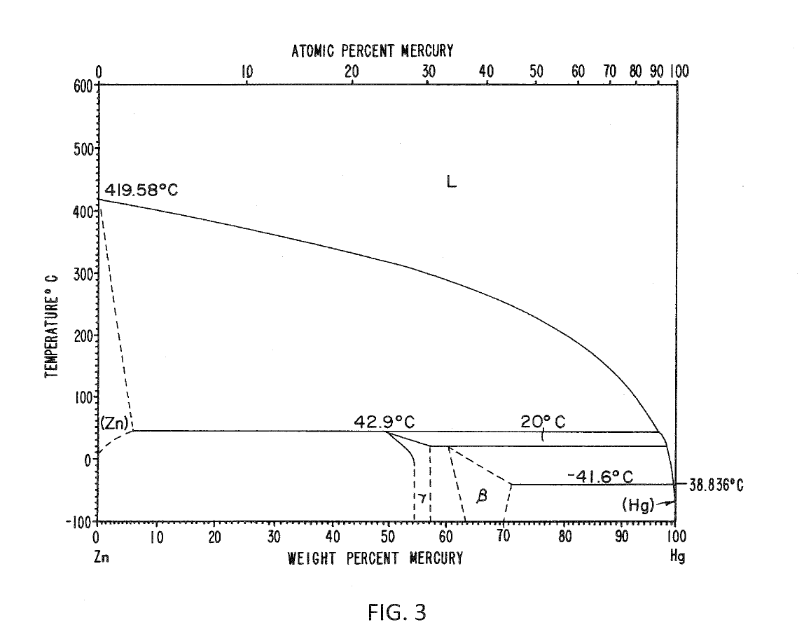

FIG. 3 is the binary Zn—Hg phase diagram. A pellet produced in accordance with some embodiments contains the Zn₃Hg phase; other phases may be present. The β phase (nominally Zn₂Hg) may be present. The Hg₃Zn phase may also be present. The β phase and the Hg₃Zn phase are not normally present in the Zn—Hg quenched from high temperature. Prior art approaches (CN 10100848 and CN 2836231) rely on a film on the outside of the pellet. An outside film is not needed in various embodiments of the present disclosure. In some embodiments, a reaction may occur between coated layers, and a novel material is provided after the reaction is completed. The reaction may occur between layers in the plated layers or between the substrate and the mechanically plated material. The result may be the creation of a new phase. One unexpected result of the present invention is the improved appearance of mechanically plated Zn—Hg pellets.

Solid Substrate

A solid substrate can be plated with Zn—Hg at or near room temperature. The substrate may vary in size and shape. For instance, a spherical particle may be used. Other particle shapes are within the scope of the present invention. The substrate material may be metallic, such as iron or steel, ceramic (such as aluminum oxide), vitreous (such as glass), or plastic. The substrate particle may have a porous or hollow interior and exterior and may be itself constructed of several layers of the abovementioned materials. In some embodiments, a pellet produced by mechanical plating includes up to 98 wt % substrate.

Coating Thickness

The thickness of the plating may be controlled, allowing one to prepare particles of arbitrarily low mercury content and large diameter, which are not possible with the prior art, melt-based approach.

Multiple layers may be coated on a single solid particle. These layers may have the same composition within normal tolerances, or they may comprise a set of different metals and amalgams situated so as to provide a novel and useful structure. The applied layers may include a gradient of compositions. Typical coating thicknesses are between 0.5 μm and 5000 μm. Thicker and thinner coating thicknesses are possible. Coatings as thin as 0.5 μm are possible.

TGA and X-Ray Diffraction Results

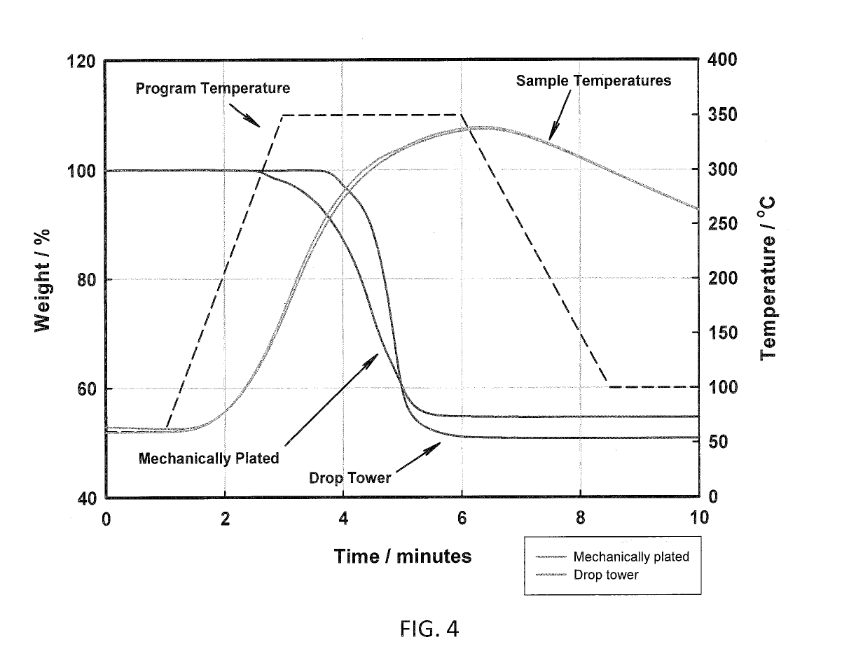

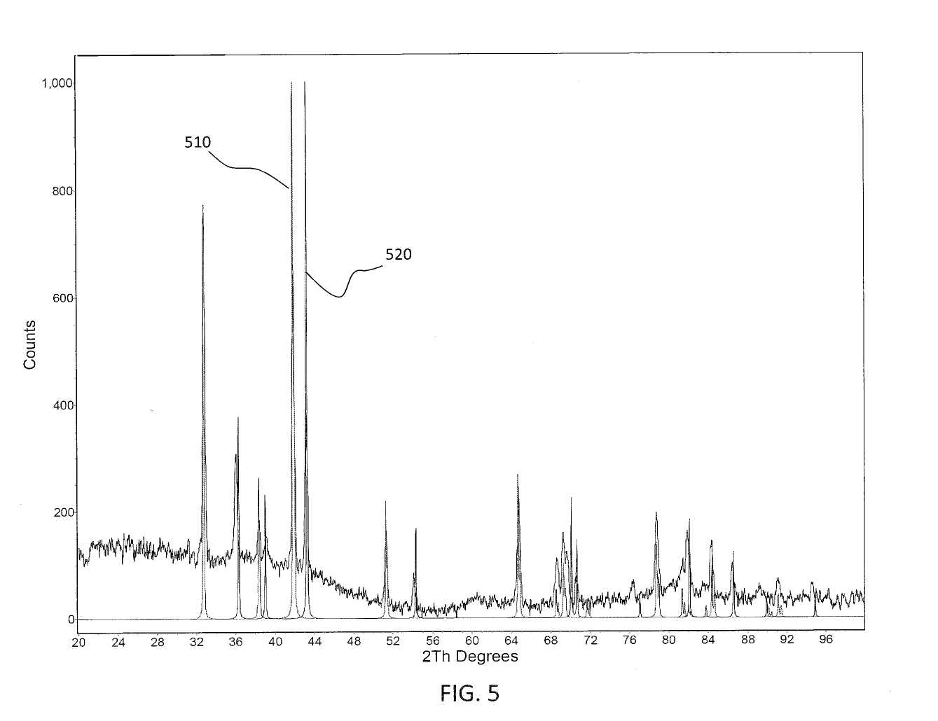

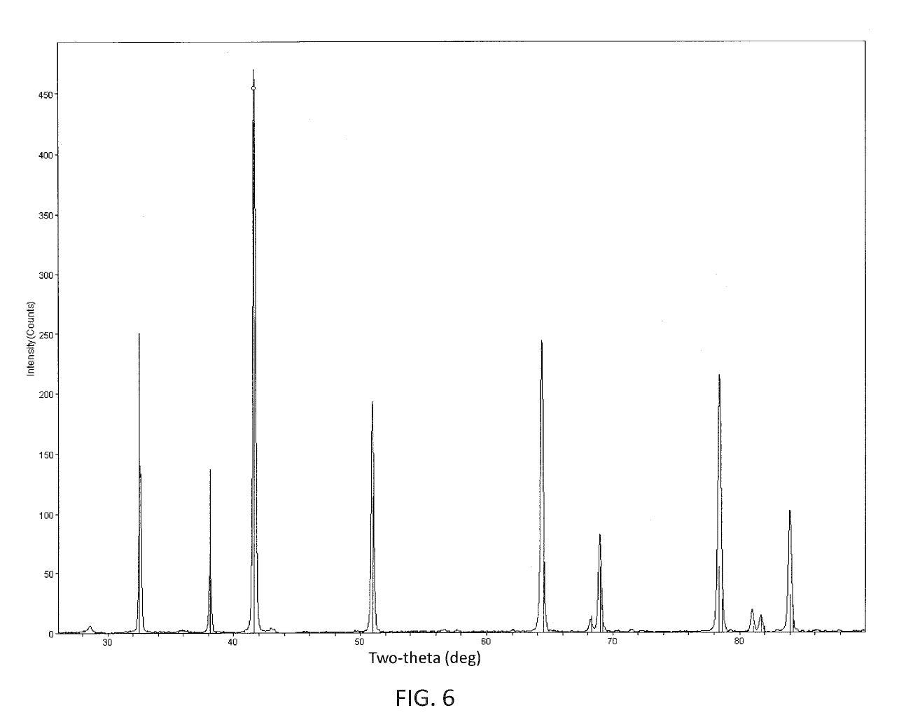

Thermogravimetric analysis (TGA) of mercury release from a 2 mm pellet that was mechanically plated with Zn—Hg is shown in FIG. 4. A Zn—Hg pellet produced in the melt-based approach is given for comparison. Both were subjected to the same temperature profile. X-ray diffraction from a mechanical plated Zn—Hg pellet and a melt-based Zn—Hg pellet are shown in FIGS. 5 and 6. The mechanically plated amalgam only shows Zn₃Hg (except a small unidentified peak at 28.5° 2θ) while the melt-based Zn—Hg shows Zn and Zn₃Hg at room temperature. Below the freezing point of mercury, a solid mercury peak is expected to be formed.

Less Hg Re-Absorption and Higher Mercury Contents Compared to Prior Art

Various embodiments allow for the preparation of a pellet which provides less mercury re-absorption if the mercury content is above 50 weight percent since less Zn solid solution is formed. Mercury contents up to 75 weight percent Hg have been mechanically plated onto solid substrates and have been solid at room temperature. The higher mercury content means there is less zinc and less zinc solid solution. Less zinc solid solution provides for less mercury re-absorption.

A structure composed entirely of Zn₃Hg is different than a structure composed of zinc solid solution, Zn₃Hg and saturated amalgam.

PS Shape

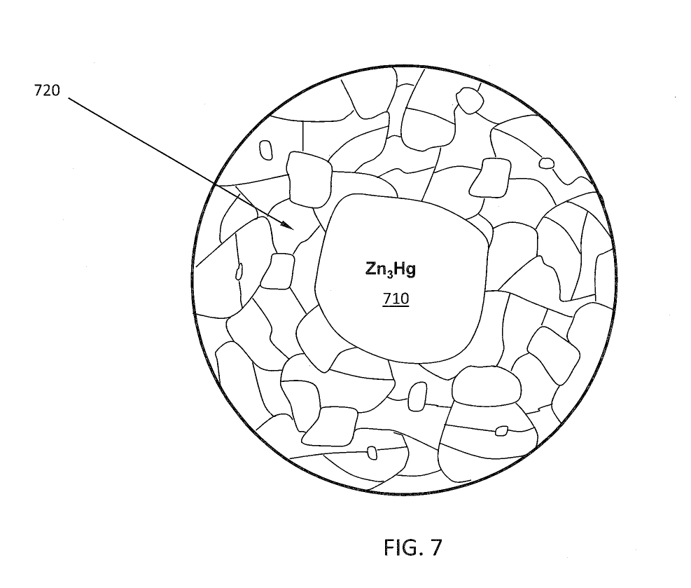

Various embodiments provide an improvement in pellet shape relative to known techniques for pellet formation. The pellets resulting from mechanical plating are rounder than those produced by the melt-based approach of Anderson, which in turn creates another advantage: higher yield. Less time is required to perform sorting and sieving with various embodiments, resulting in lower cost. An unexpected consequence of rounder pellets is that they are easier to sort, sieve and classify by size due to their rounder shape. Fewer passes through sorting equipment are needed. The net result is a significant increase in the throughput of mechanically plated Zn—Hg pellets in the sorting phase of production. As shown in FIG. 7, mechanical plating in accordance with some embodiments may be performed on a substrate particle 710 that is not spherically symmetric, to provide a coating 720 of Zn₃Hg.

Reduced Exposure to Mercury Vapor

Another advantage of some embodiments is the ability to contain mercury during the manufacturing process more readily than with the traditional method, thereby avoiding the hazards associated with mercury and molten metals at high temperatures. Since mechanical plating of various embodiments may be conducted at or near room temperature the potential hazards of mercury vapor are greatly reduced compared to those of molten Zn—Hg at 300-400° C.

Yield Improvement and Byproduct Reduction

Various embodiments produce fewer hazardous byproducts relative to known techniques for amalgam pellet production. Fewer parts are needed to contain the zinc dust and mercury and less contamination is produced. The yields are significantly higher in various embodiments; therefore, the amount of starting material needed to produce the same amount of a finished product is reduced.

Large Diameter Pellets

An advantage of various embodiments is the ability to make large diameter pellets with a low Hg dosage. The melt-based technique of Anderson requires a homogeneous liquid phase. As the overall mercury content is lowered, the liquidus temperature shown in the Zn—Hg phase diagram, FIG. 3, rises and mercury boil off becomes even more problematic. Conventional pellets are limited to 40-55 wt % Hg, which does not allow for production of large diameter solid pellets with low Hg contents, because much of the mercury is absorbed in solid solution and may not be available for vaporization in a lamp. Various embodiments allow for the creation of a thin coating that is as high as 75 wt % Hg.

Low Mercury Doses

Some embodiments allow for the creation of very low mercury doses on large diameter pellets. A low mercury dose is sometimes appropriate in fluorescent lamps. The trend toward less mercury will continue due to environmental concerns. Since conventional, melt-based Zn—Hg pellets have a minimum mercury content of about 40 wt % it will be difficult to use conventional approaches to continue reducing mercury contents and still maintain a manageable diameter for dosing equipment. A preferred solution is to mechanically plate a thin layer of Zn—Hg containing a small amount of mercury. This layer consists of Zn—Hg with a high Hg:Zn ratio (which may be greater than a Hg:Zn ratio of 55:45) on a solid substrate. Various embodiments allow the manufacture of such a pellet.

### Non-Equilibrium Materials

The unique ability to bypass phase diagram constraints allows the possibility of creating many new and useful materials, especially materials that resist Hg re-absorption, have unique diameter/Hg contents, or have useful vapor pressure regulation properties.

Additional advantages of various embodiments are made possible by mechanical plating of the constituents onto the surface of solid spheres. Metastable phases can be created, as will be shown in the examples below. Materials with low or no mercury re-amalgamation may be produced. As will be shown in the examples, a Bi—Hg material with 50 wt % Hg may be made.

### Getters

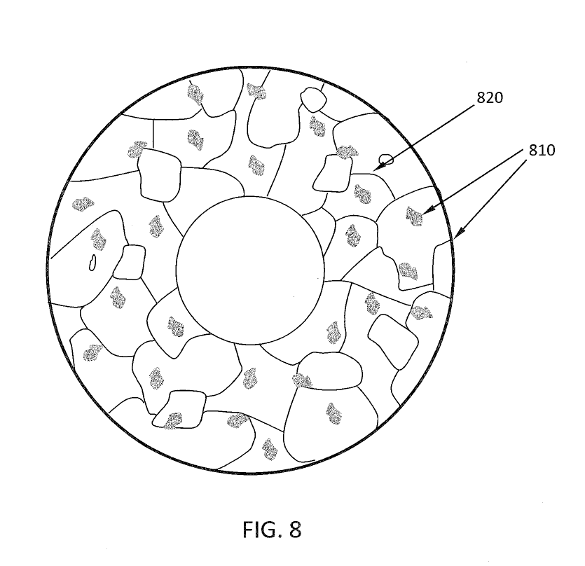

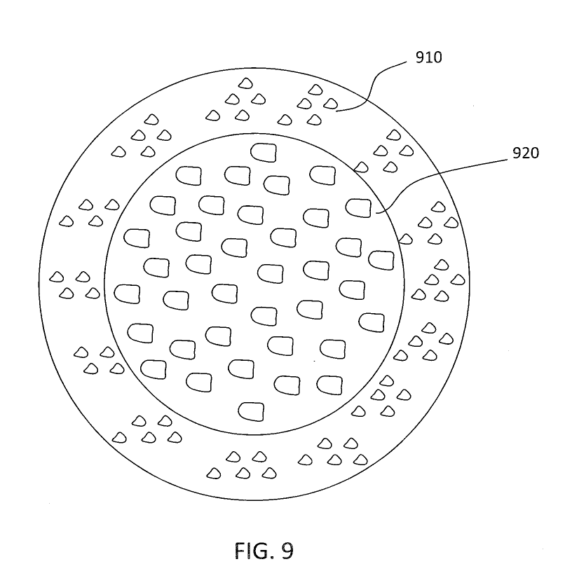

Various embodiments allow for the possibility of a layered structure of different compositions and thicknesses and for the incorporation of insoluble materials such as gettering materials. Getters may be useful in absorbing hydrogen from the inside of the lamp. They may be present, in physical contact with Zn amalgam, or physically separated from the amalgam as an outside layer on the amalgam. Either concept can be used, in principle, to getter hydrogen in the lamp. FIG. 8 is a schematic diagram of a getter 810 in physical contact with Zn—Hg amalgam 820. FIG. 9 is a schematic diagram of a getter 910 that is not in physical contact with Zn—Hg amalgam 920. Both gettering techniques are provided in various embodiments. Getters may not evaporate at 300° C., and may be made from metals, alloys, or oxides.

Premix may include materials having a porous structure that advantageously absorb gases (e.g., vapors of metals such as mercury or organometallics, or impurity gases such as water vapor).

The zinc-mercury premix may contain an inert material that becomes active upon heating. An example of such a material is a low temperature hydrogen getter such as Zr—Co—Rare-earths or ZrMn₂ as described in U.S. Pat. Nos. 4,586,561 to Franco and 5,961,750 to Boffito. Other getter alloys may also be used. Several of these materials have activation temperatures of about 300° C. or less, which is a low enough temperature to have the mercury boil off of Zn—Hg and allow the getter material to be activated. Thus, a Zn—Hg pellet may be designed to have an integral getter capability.

Process Control and Production

Process control is improved in various embodiments because the procedure for making Zn—Hg by mechanical plating is simpler and fewer steps are involved than with prior approaches. Quenching is not a problem in the mechanically plated material. In the melt-based approach, excessive quenching can lead to Zn—Hg pellets which are farther from equilibrium and very sticky. Insufficient quenching can lead to deformed pellets or pellets which sinter together.

Pellet production in accordance with various embodiments is faster than with prior art approaches. The production process can be interrupted. The operation is less sensitive to operator skill and can be performed without a vacuum system and without a quenching system. Less clean-up is needed than with conventional methods. The new process is rapid; the mechanical plating process may be completed in a matter of minutes. Pellets are generally not sticky (or can be made free flowing) when finished.

### Possible Materials

Materials that may be used for coating solid substrates include: zinc, tin, copper, nickel, bismuth, titanium, lead, gallium, aluminum, cobalt, indium, manganese, iron, vanadium, silver, gold, cadmium, thallium, antimony, silicon, germanium, magnesium, strontium, boron, palladium, platinum, rhenium, tungsten, molybdenum, tantalum, zirconium, hafnium, niobium, graphite, chromium, barium, calcium, lithium, strontium, sodium, selenium, tellurium, ruthenium, scandium, cerium, europium, dysprosium, thulium, yttrium, praseodymium, gadolinium, holmium, ytterbium, lanthanum, samarium, terbium, erbium, lutetium, a boride, a carbide, a nitride, an oxide, a hydride, an aluminide, a silicide, a phosphide, a sulfide, a fluoride, a chloride, a gallide, a germanide, an arsenide, a selenide, a bromide, an indide, a stannide, an antimonide, a telluride, an iodide, a thallide, a plumbide, and a bismuthide.

Amalgams Other than Zn—Hg

Other metals may be incorporated into Zn—Hg or in place of Zn. Such additions are more easily performed in various embodiments than in the melt-based prior art. Other components such as nickel, tin, etc, may easily be added to the zinc-mercury amalgam formed at room temperature when they are in the form of finely divided powders, nominally between 5 and 50 μm, in size. Several layers of materials may be constructed in the present invention. A layer of Zn—Hg may be followed by a layer of Sn—Hg and then by a layer of Zn—Sn—Hg. The concentration of the Hg in the sphere may be adjusted up or down. Typically, 50 wt % Hg is used in Zn—Hg. Manganese, nickel, titanium, iron and other transition metals have been incorporated into amalgams by various embodiments. Copper and silver have been successfully incorporated into amalgams.

Various embodiments do not require quenching of molten droplets. Amalgamation or alloying probably occurs on a microscopic level under high local pressure, not overall (or total pressure).

Various embodiments enable mechanically plating of metal powders with melting points above 500° C. These high melting point metals may be incorporated into a coating either separately or with low melting point metals. The prior art method of producing Zn—Hg cannot incorporate metals, such as Ni or Mn, which raise the liquidus temperature above about 350° C.

Materials that were not possible by the prior art method of manufacture are now possible. For example, additions of Ni to Zn—Hg and Mn to Bi—Hg have been made. These amalgams cannot be made by the method of Anderson because the liquidus temperature of Ni—Hg or Mn—Hg rises dramatically with very small nickel or manganese content. Mercury boil-off would be extreme if nickel were added to zinc-mercury binary amalgam. As will be explained in the examples below, amalgams containing nickel, manganese, titanium and copper have been made.

Furthermore, more novel materials, heretofore untested, may be created by various embodiments, including aluminum amalgam and titanium amalgam.

The novel material may be layered and include both electroplating and mechanical plating, in any order, but does not rely solely upon electroplating as in U.S. Pat. No. 1,518,622 to Wernlund. For example, a Bi—Sn—Hg amalgam was electroplated in some embodiments with a thin copper layer to provide a high temperature barrier to mercury release. Some embodiments may include cementation and/or sonochemical reactions in addition to mechanical plating.

Rare Earth Amalgams

Rare earth amalgams are known to exist. Prior art methods of manufacturing rare earth amalgams include direct synthesis of the elements at high temperature. High temperature synthesis is a slow process with a constant danger of explosion and exposure to mercury vapor. Various embodiments alleviate both of these problems by forming an amalgam at room temperature.

Temperature Controlled Amalgams

Temperature-controlled fluorescent lamps may be made in accordance with various embodiments. A temperature controlled fluorescent lamp is one in which the Hg vapor pressure is essentially that of pure Hg at the cold spot temperature of the lamp. Various embodiments pertinent to temperature controlled lamps include, but are not limited to, compositions for reducing mercury re-absorption, such as by using Bi—Hg, and compositions for high mercury contents, such as Bi—Hg with 60 wt % Hg and Sn—Hg with 50 wt % Hg.

Zn—Sn—Hg amalgams have been made at room temperature in accordance with various embodiments. Such amalgams were free flowing and shiny. Bi—Zn—Hg was made at room temperature in accordance with various embodiments.

Bi—Hg is a novel material produced in accordance with various embodiments. At equilibrium, binary amalgams composed strictly of bismuth and mercury (Bi—Hg) are a heterogeneous mixture of liquid and solid above −39° C. and as such, are not useful as lamp dose materials. To be useful, such amalgams must be mixed with a third alloying element such as Sn or In, e.g., Bi—Sn—Hg and Bi—In—Hg, to be solid at room temperature. Contrary to expectations, a solid bismuth-mercury amalgam pellet was created at room temperature in accordance with some embodiments and was tested by the usual methods. The results suggest that binary Bi—Hg is in a metastable condition but is useful for certain mercury dispenser applications where little or no re-absorption of mercury can be tolerated. This material cannot be made by melt-based jetting methods.

In addition to the advantages over the prior art mentioned earlier, Bi—Hg has several additional advantages. For example, little or no mercury re-absorption by bismuth after mercury release is expected; therefore it is a useful material and an improvement to Zn—Hg. A Bi—Hg premix (especially 50 wt % Bi and 50 wt % Hg) is preferred for this material.

Sn—Hg with 50 weight percent Hg may be made at room temperature in accordance with some embodiments, with an overall mercury content up to 60 weight percent Hg.

An amalgam of tin and mercury containing 50 wt % Hg is a mixture of liquid and solid at room temperature when fully equilibrated. Fully equilibrated Sn—Hg amalgams should contain 20 wt % Hg or less to be solid and free flowing. A mechanically plated Sn—Hg amalgam with up to 50 wt % Hg having a coating on the surface to prevent liquid at the surface from sticking to other pellets may be made in accordance with some embodiments.

Zn—Ti—Hg amalgam is a novel material produced in accordance with some embodiments. Other novel materials include Zn—Mn—Hg, Bi—Mn—Hg and Bi—Ti—Hg. These materials may be temperature-controlled amalgams.

A binary manganese-mercury amalgam may be made in accordance with some embodiments. The composition contains between about 30% and 90% by weight mercury.

### Regulating Amalgams

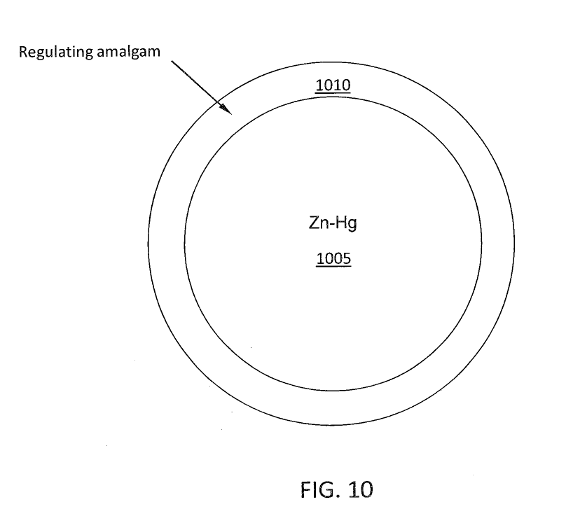

Regulating amalgams may be produced at room temperature in some embodiments. Regulating amalgams are amalgams in which the vapor pressure of Hg is determined by the equilibration of Hg with the other components of the amalgam pellet, thus reducing and regulating the Hg vapor pressure at a lower level over a range of operating temperatures. A regulating amalgam may be used to coat Zn—Hg. The Zn—Hg may act as a reservoir for mercury and the surface may regulate the vapor pressure. This material may require substantially less indium and bismuth than a sphere made entirely of Bi—In—Hg. There may be significant cost savings if the surface amalgam regulates the vapor pressure and the inner core supplies mercury. FIG. 10 is a schematic drawing of a regulating alloy or amalgam 1010 covering an amalgam 1005, which is a porous reservoir for mercury.

High Pressure Discharge Amalgams

Improvements and innovation to amalgams used in high pressure discharge lamps are within the scope of various embodiments. Many high pressure discharge lamps contain sodium or cesium. Binary amalgams of sodium and cesium, which have previously been produced by the method of Anderson, may be modified in accordance with various embodiments. For instance, a Na—Hg amalgam containing 90 weight percent Hg and 10 weight percent Na, may be used as the solid substrate for mechanical plating. Amalgams of thallium, indium and other metals useful in high pressure discharge lamps may be added to the surface of the alkali metal amalgam.

Alloy Formation in Mechanically Plated Amalgams

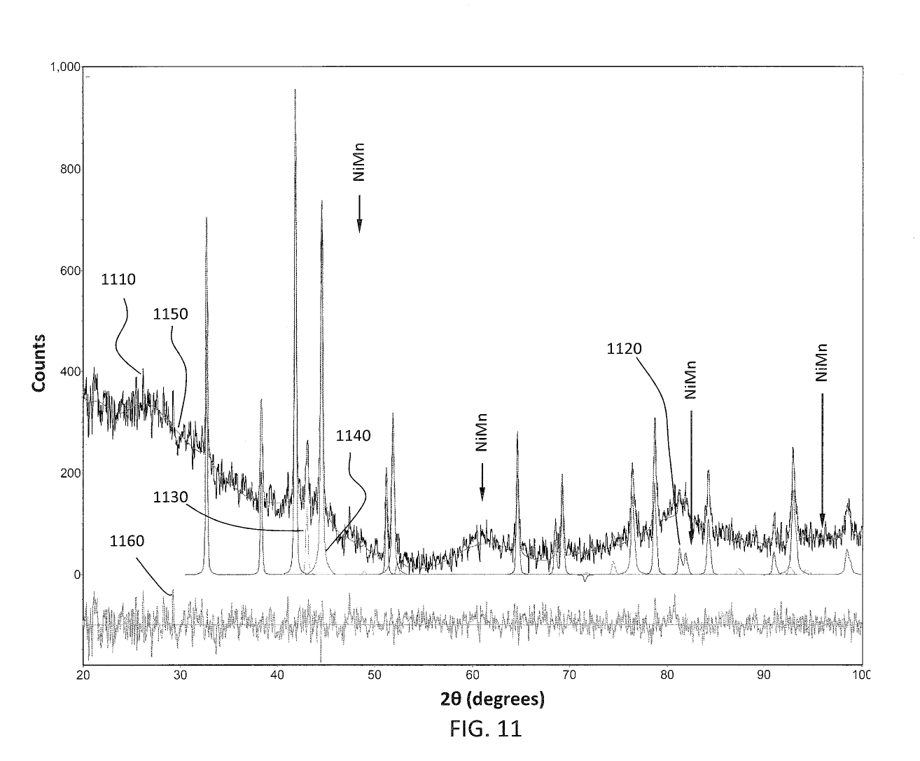

An unexpected consequence of some embodiments is the room temperature formation of an alloy between two high melting point metals that were originally present as metal powders. The resulting alloy phase does not contain mercury. For instance, a Zn—Ni—Mn—Hg amalgam was mechanically plated onto a glass sphere. X-ray diffraction revealed the formation of a binary NiMn alloy. FIG. 11 shows the x-ray diffraction pattern from the Zn—Hg—Ni—Mn amalgam and identifies the NiMn alloy and Zn₃Hg. In FIG. 11, plot 1110 is the collected pattern, plot 1120 is a refined HgZn₃ phase, plot 1130 is a refined MnNi phase, plot 1140 is a refined Ni phase, plot 1150 is an overall refined fit, and plot 1160 is a calculated difference.

This process may be used to create otherwise expensive and difficult to synthesize compounds at room temperature instead of at high temperatures. In the past, mercury has been used as a flux for the synthesis of, for instance, rare-earth manganese compounds. After synthesis, the mercury is boiled away and a high temperature alloy is formed. The new alloy is adherent to the substrate upon which it was formed.

Now, the technique can be expanded to form a wider range of compounds and to plate them onto a spherical object. This process, called the “double flux” method, because it relies on two metal fluxes rather than one, may be expanded to form other intermetallic compounds. The mercury can be removed by boiling it away. Zinc may be removed by oxidation.

A number of new or difficult to fabricate compounds may be manufactured. For example, Ni—Al—Zn—Hg may produce useful NiAl high temperature compounds, Nb—Zn—Sn—Hg may be used to produce Nb₃Sn, a superconductor, and Zn—Ni—Ta—Hg may be used to produce a novel Ni₃Ta shape memory alloy.

In some embodiments, a particle contains substantially all Zn₃Hg phase. Embodiments do not preclude the formation of other Zn—Hg phases, either stable or metastable, which may be discovered in the future.

One embodiment includes 50 wt % Hg and 50 wt % Zn on substrate beads. Other compositions are possible, but 50% Hg creates an excellent coating that is adherent and is lustrous. Pellets have excellent roundness and free flowing properties. The preferred composition (50 wt % Hg) produces a nearly homogeneous Zn₃Hg phase on the surface of the pellets. FIG. 5 shows x-ray diffraction from a mechanically plated Zn—Hg pellet. In FIG. 5, plot 510 shows Zn₃Hg and plot 520 shows Zn solid solution. The results show only a single phase present, namely Zn₃Hg.

The water content of the material is preferably less than 50 ppm and even more preferably less than 20 ppm. The coated structure is solid, dense and adherent, with a substantially uniform thickness. A coating thickness of between 50 μm and 2500 μm is preferred. Thicknesses as low as 1 μm and as high as 5 mm are possible.

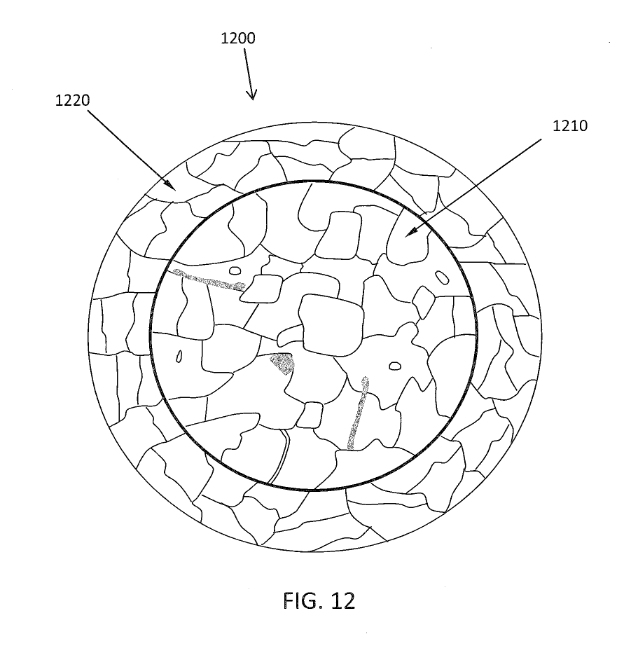

Another embodiment involves coating existing Zn—Hg spheres with premix. This allows the re-work of existing material. FIG. 12 shows a schematic representation of the cross section of one of these pellets 1200. Zn—Hg region 1210 of pellet 1200 was formed by the melt-based approach, and Zn—Hg region 1220 is formed by mechanical plating in accordance with some embodiments. An advantage of such re-working is to increase the yield of the prior art method. Furthermore, it is believed, that a coated layer of premix, essentially all Zn₃Hg, stays brighter and may be more resistant to air oxidation for a longer period of time than melt-based Zn—Hg. Zn—Hg pellets have successfully been coated with Zn—Hg.

### Regulating Amalgams

Embodiments may provide regulating amalgams comprising Bi dust, In dust, Zn dust and liquid Hg. Thus, Bi and In dust together with Hg, In dissolved in Hg, or Bi, Zn, and In dust mixed together and then shaken with Hg, or any other combination thereof may be used to form an amalgam pellet. Mercury does not dissolve in bismuth to any meaningful extent. The use of nickel as a component of regulating amalgam has been neglected in the past because it cannot be jetted into a pellet. Some embodiments provide regulating amalgams comprising tin, copper, silver, gold, lead, nickel, bismuth, indium and/or mercury. U.S. patent application Ser. No. 11/526,720 disclosing an indium-bismuth-zinc amalgam is incorporated by reference herein in its entirety.

Lamp

Some embodiments provide a fluorescent lamp with an improved zinc amalgam. The fluorescent lamp may have a zinc amalgam comprising zinc, mercury and optionally a material suitable for absorbing hydrogen, i.e., a getter. Some embodiments provide for a temperature-controlled fluorescent lamp and other embodiments provide for an amalgam controlled fluorescent lamp with a mercury dose and a novel method of introducing a precise, low mercury dose. Temperature-controlled lamps and amalgam controlled lamps are described at, e.g., U.S. Pat. No. 5,882,237, “Fluorescent lamp containing a mercury zinc amalgam and a method of manufacture,” to Sarver et al.

A still further object of the present invention is to provide a high pressure discharge lamp with an amalgam dose in the form of a mechanically plated object. The mechanically plated object may contain any of the plateable metals and compounds defined previously.

Lamp production is easier with a rounder amalgam and lamp performance may be improved if the mechanically plated amalgam contains a getter. Lamp performance (run-up) may be enhanced by a novel material (Bi—Hg, etc.) that is subject to less mercury re-absorption than in the prior art. Lamp life may be extended by a mechanically plated amalgam that does not have any mercury re-absorption or that has less re-absorption than melt-based Zn—Hg. Lamp performance and life may be extended by a mechanically plated amalgam containing a getter.

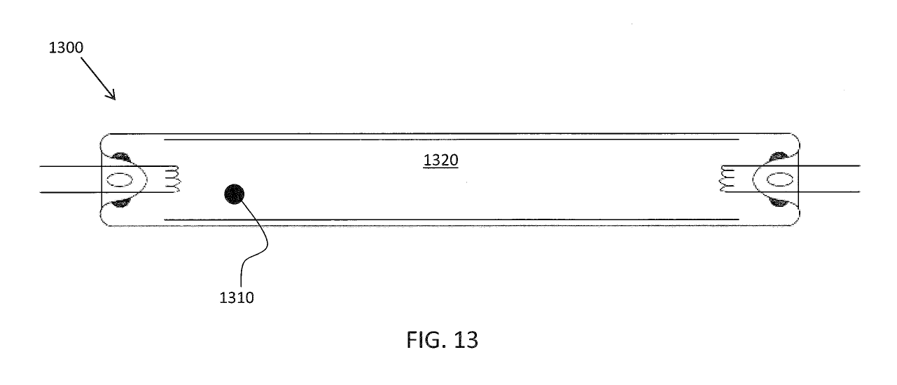

FIG. 13 is a diagram of a lamp 1300 containing a mechanically plated amalgam pellet 1310. The amalgam pellet 1310 is released into a discharge chamber 1320 of the lamp and provides a precise dose of mercury as the mercury is vaporized during lamp operation. The mercury vapor efficiently converts electrical energy to ultraviolet radiation with a wavelength of approximately 253.7 nm when the mercury vapor pressure is in the range of approximately 2×10−3 to 2×10−2 torr. The ultraviolet radiation is absorbed by a phosphor coating on the interior of the lamp wall and converted to visible light.

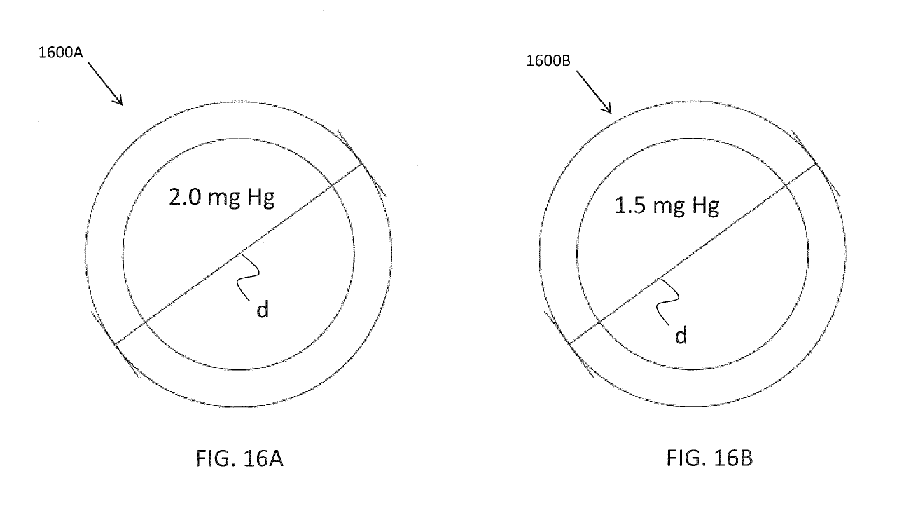

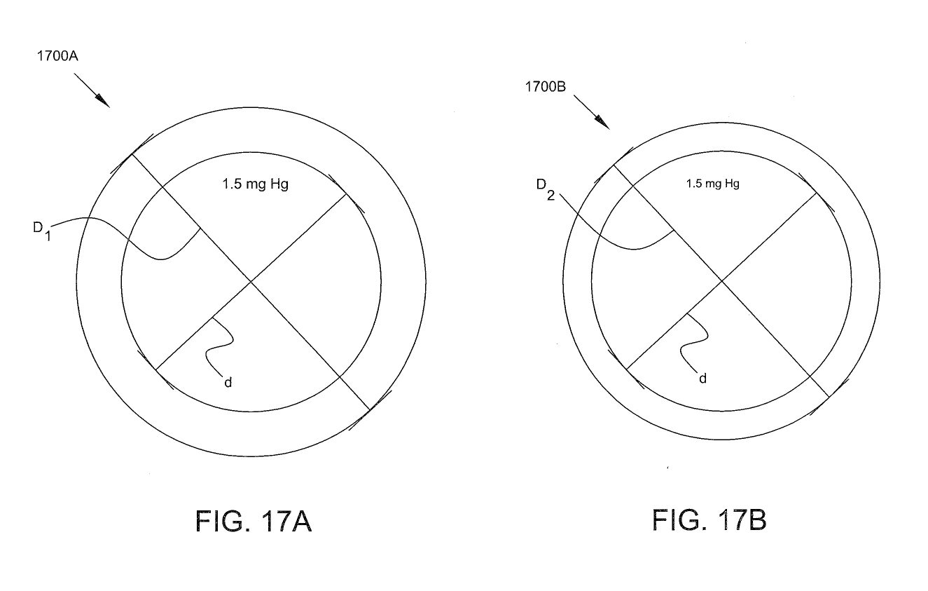

In some embodiments, a fine powder (e.g., glass microspheres) is used in the premix. The glass powder in the premix that is applied to a substrate may have a diameter between 1 μm and 100 μm and provides several advantages, including conservation of relatively expensive metal powder and the provision of new surfaces that may be used to absorb excess mercury. The glass powder may have a single particle size, a bimodal distribution or a multimodal distribution, and may be spherical, irregularly shaped or a combination thereof. Adding glass powder to premix advantageously enables the creation of amalgam pellets having the same diameter but different amounts of mercury, as shown in FIGS. 16A-B. Pellets 1600a and 1600b in FIGS. 16A and 16B have the same diameter (shown as diameter d) but different amounts of mercury (2.0 mg and 1.5 mg, respectively). Also, addition of glass powder to premix allows for pellets having the same mercury content but different diameters, as in FIGS. 17A-B. FIGS. 17A and B show two pellets 1700a and 1700b that have the same substrate diameter d and the same amount (1.5 mg) of mercury, but different overall diameters D1 and D2. Addition of glass dust may help materials remain flowing at 40° C., which avoids stickiness and promotes successful application of the pellets. For example, Bi—Zn—Hg is normally sticky, but addition of glass dust may render the material free flowing.

In some embodiments, a fine iron powder (e.g., having a diameter between 5-50 μm) may be used in premix to form a homogeneous coating of discrete particles. Thus, magnetic coated pellets are provided by mechanical plating in some embodiments. Handling and dispensing of pellets may be facilitated if the pellets are magnetic. Such composite structures may be readily prepared by mechanical plating. Less zinc may be required than in prior art pellet formation techniques, so mercury re-absorption is advantageously reduced. Less zinc is required since the iron (or other inert powder) provides the bulk of the solid contained in the composite pellet. Zinc acts as a binding agent to hold the pellet together. The zinc may also promote wetting of the iron surfaces, further binding the composite pellet.

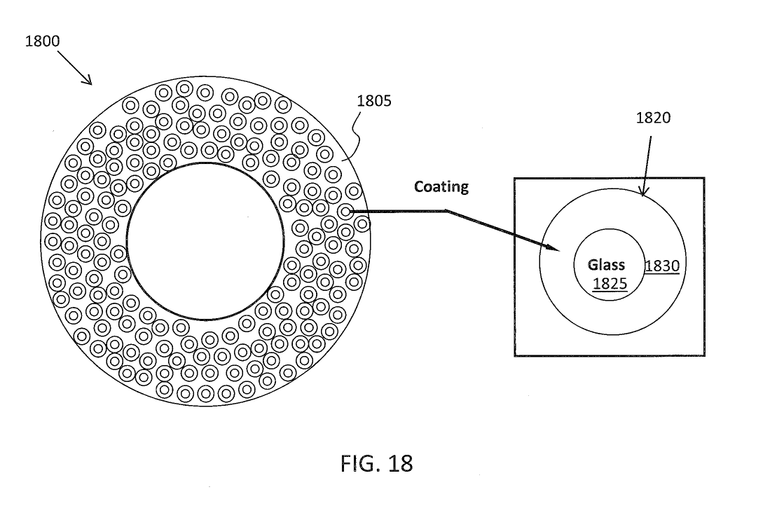

FIG. 18 is a schematic representation of a substrate coated with a coating by mechanical plating, with the coating itself including pre-coated particles. A pellet 1800 is formed by mechanically plating a material 1805 onto a substrate 1810. The material 1805 that is plated onto the substrate 1810 includes particles 1820 that are composed of a core 1825 and pre-coated with material 1830. Thus, pre-coated objects may be embedded in a mechanically plated layer. Pre-coated objects may be prepared by various methods including chemical vapor deposition, electroplating, spraying, physical vapor deposition, etc. The thin pre-coated layer 1830 may thus allow extremely small amounts of material to be incorporated into pellet 1800.

In some embodiments, multiple layers having different compositions may be mechanical plated onto a substrate. In other words, a first layer having a first composition may be plated onto a substrate core, and a second layer having a second composition may be plated onto that, etc Additional layers may be added to absorb free mercury or prevent stickiness).

In some embodiments, a first layer that is mechanically plated is a stable equilibrium structure (e.g., Zn), and a second layer is a metastable, non-equilibrium layer (e.g., Sn—Hg) that is mechanically plated onto the first layer. In some embodiments, a first layer is a single phase structure (e.g., Zn), and a second layer is a two-phase (e.g., Sn—Hg) or multiphase material.

In some embodiments, one or more new materials are synthesized. For example, a mixture of Ni—Mn—Zn—Hg employed in accordance with some embodiments produces Zn₃Hg and NiMn intermetallic compounds.

In some embodiments, the coating may react with the substrate. The plated material may release mercury. In some embodiments, the plated material does not re-absorb mercury. In other embodiments, the plated material may re-absorb significantly less mercury than prior art materials.

### EXAMPLES

The following examples and methods are provided to elaborate on the concepts described above associated with various embodiments. Many additional examples and concepts related to mechanical plating of metals and their compounds are possible to those skilled in the art.

A plurality of amalgam pellets with different compositions and sizes may be incorporated into a single shaking container for the net effect of accomplishing a desired amount of alloying, reduction, oxidation, chemical reaction or pellet production. Various embodiments provide multiple ways to obtain the same or substantially the same end result: a pellet coated with amalgam. alloy, or other material or compound.

### Example 1a

### Improved Zn—Hg Pellets

A premix was made by adding 1000 g of vacuum-dried Zn dust (5-8 μm particle size) and 1000 g of high-purity mercury to an argon-filled container that was about ¼ full when both were added. The mixture was shaken for 5 minutes.

A second container was filled to ⅓ A full with 175 g of 2 mm glass beads. The premix was then added to the glass beads with 30-40 seconds of shaking between additions of premix. The pellets were substantially round and with uniform composition.

### Example 1b

### Composition of Zn—Hg by Mechanical Plating and by Melt-Based Technique

The composition of 10 batches of melt-based Zn—Hg and 10 batches of mechanically plated Zn—Hg were measured by inductively coupled plasma (ICP) mass spectrometry. The average Hg composition of the mechanically plated material was, within experimental limits, closer to the targeted 50% value than for the melt-based Zn—Hg.

### Example 2

This example compares the yield of a melt-based process with that of the mechanical plating method. The yield from 11 batches of melt-based Zn—Hg was measured, and the average yield was determined to be 70%.

The yield from 9 batches of mechanically plated Zn—Hg was measured and the average yield was determined to be 99%. Thus, mechanical plating produces a much higher yield.

### Example 3

### Mechanically Plated Bi—Hg (50 wt % Hg)

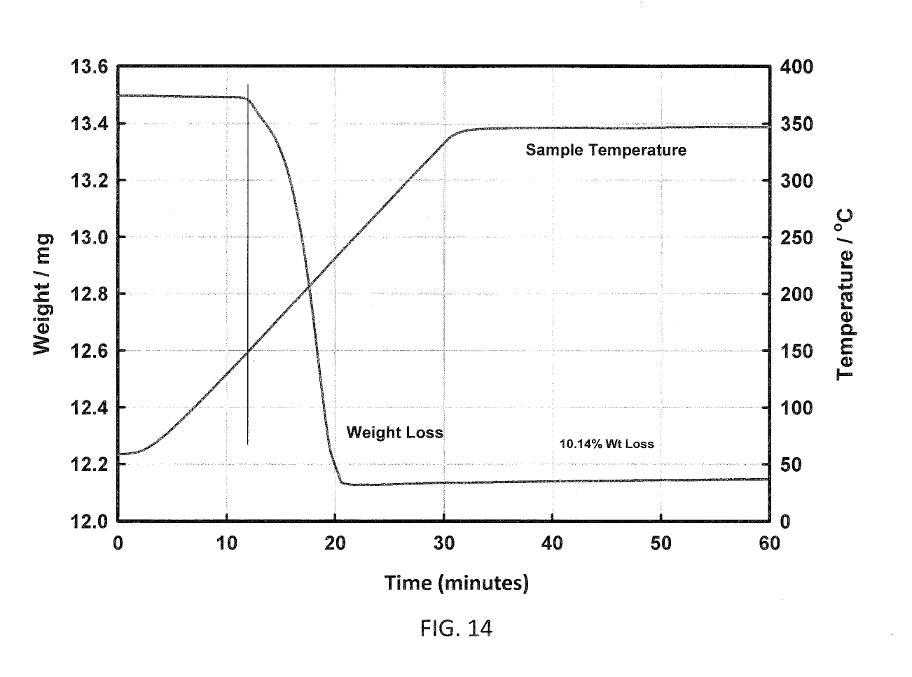

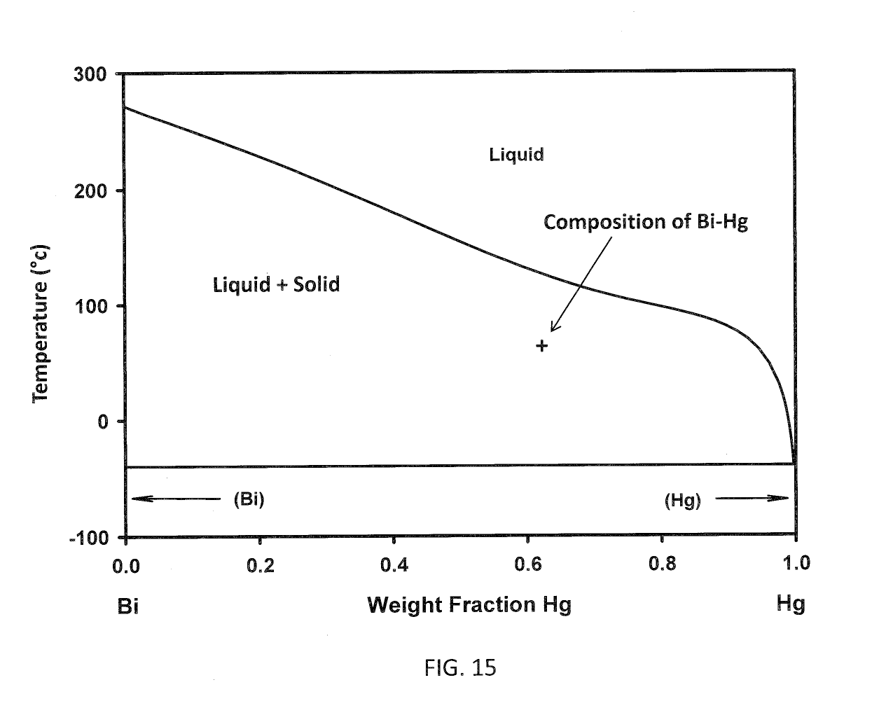

A promoter layer of Zn—Hg was applied to the surface of the glass beads to be coated with Bi—Hg. A 50 weight percent bismuth and 50 weight percent mercury pellet was made on a spherical particle. These were mixed in a shaker for a 90-120 minutes prior to mechanical plating. The measured metal content of the final mechanically plated pellet was coated with a film of Bi—Hg having a composition of 49.8 weight percent Bi and 50.2 weight percent Hg. Thermogravimetric analysis was performed on a pellet of this material. The initial mass of the spherical pellet was 13.496 mg and the final weight is 12.128 mg. The weight loss was 1.368 mg and the percent weight loss was 10.14%. A TGA curve from the sphere is given in FIG. 14. The resulting pellets were free flowing and solid at room temperature with a slight tendency toward oxidation. The Bi—Hg binary phase diagram is shown in FIG. 15.

### Example 4

Sn—Hg amalgam premix was made using 50 wt % Sn powder and 50 wt % Hg. These were mixed for a few minutes prior to mechanical plating. A promoter layer of Zn—Hg was applied to the surface of the glass beads to be coated with Sn—Hg. Sn—Hg amalgam was plated onto the glass beads by shaking for about 90-120 seconds. The resulting pellets were free flowing and solid at room temperature.

### Example 5

16.7 grams of nickel powder, 16.7 grams of manganese powder, 16.7 grams of zinc dust and 50 grams of mercury were added together in a shaking container. The mixture was processed for 90 seconds. A nickel-manganese-zinc-mercury amalgam was formed when the premix of these metals was added to 175 g of glass beads and shaken together at room temperature for 90 seconds. The resulting pellets were subjected to x-ray diffraction. A binary nickel-manganese alloy was identified from the diffraction spectrum shown in FIG. 11.

### Examples 6-19

### Other Coating/Substrate Combinations

Pellets that were prepared having various coatings and substrates in accordance with embodiments are shown in Table 1.

TABLE 1
Mechanically plated pellets with various coatings and substrates

| | | | | Compo- |
|---|---|---|---|---|
| | | | | sition of |
| | | Composition of | | Substrate/ |
| Example | Coating Material | Coating/wt % | Substrate | wt % |
| 6 | Zn—Hg | 50-50 | Steel | |
| 7 | Zn—Hg | 50-50 | Zn—Hg | 50-50 |
| 8 | Zn—Sn—Hg | 25-25-50 | Glass | |
| 9 | Cu—Zn—Hg | | Glass | |
| 10 | Zn—Ni—Hg | | Glass | |
| 11 | Zn—Ti—Hg | 47.5-2.5-50 | Glass | |
| 12 | Bi—In—Zn—Hg | | Glass | |
| 13 | Zn—Fe—Ni—Hg | 15-10-25-50 | Glass | |
| 14 | Zn—Ni—Mn—Hg | 16.7-16.7-16.7-50 | Glass | |
| 15 | Bi—Mn—Hg | | Glass | |
| | (Zn—Hg promoter) | | | |
| 16 | Bi—Zn—Hg | 64-25-29 | Glass | |
| 17 | Zn—Ag—Ni—Hg | 35.5-5.1-5.3-54.0 | Glass | |
| 18 | Zn—C | 95-5 | Glass | |
| | (graphite promoter) | | | |
| 19 | Zn | 100 | Glass | |

### Example 20

Glass microspheres (e.g., having diameter between 5-50 μm) may be added to Zn—Hg premix. Mechanical plating in accordance with various embodiments may form a coated sphere with a desired Hg content, diameter, or mass. For example, a coating composition may be 45 wt % Zn, 45 wt % Hg, and 10 wt % glass microspheres.

### Example 21

Glass microspheres (e.g., having diameter between 5-50 μm) may be added to Bi—Zn—Hg premix. Mechanical plating in accordance with various embodiments may form a sphere that does not stick to other such spheres at 40° C.

### Example 22

Iron powder (e.g., having diameter between 5-50 μm) may be added to Zn—Hg premix. Mechanical plating in accordance with various embodiments may form a sphere that carries mercury and is magnetic, with 40 wt % Fe, 10 wt % Zn, and 50 wt % Hg.

Although examples are illustrated and described herein, embodiments are nevertheless not limited to the details shown, since various modifications and structural changes may be made therein by those of ordinary skill within the scope and range of equivalents of the claims.

What is claimed is:

1. A method of coating a substrate with a layer comprising:
providing a substrate in a container;
providing impact media in the container;
providing a plurality of solid particles comprising a first material in the container;
providing a liquid comprising a second material in the container; and
mechanically moving the container to thereby effect the mechanical plating of a layer comprising the first and second materials onto the surface of the substrate.

2. The method of claim 1 wherein the layer is a first layer, the method further comprising:
providing a plurality of solid particles comprising a third material, different from the first material, in the container;
providing additional liquid comprising the second material in the container; and
mechanically moving the container to thereby effect the mechanical plating of a second layer comprising the second and third materials onto the surface of the first mechanically plated layer.

3. The method of claim 1 wherein the impact media comprise a plurality of substrates to be coated.

4. The method of claim 3 wherein the substrates are generally spherical.

5. The method of claim 1 wherein the first and second materials are metallic elements.

6. The method of claim 1 wherein the layer formed by mechanical plating comprises an alloy of the first and second materials.

7. The method of claim 6 wherein the layer formed by mechanical plating comprises an amalgam of the first and second materials.

8. The method of claim 1 wherein the layer formed by mechanical plating comprises a homogeneous mixture of the first and second materials.

9. The method of claim 1 wherein the second material is mercury and the first material comprises one or more materials selected from the group consisting of zinc, tin, bismuth, iron, scandium, yttrium, indium, lead, gallium, cadmium, silver, copper, gold, aluminum, thallium, titanium, zirconium, manganese, nickel, chromium, cobalt, molybdenum, tungsten, alkali metals, alkaline earth metals, and the lanthanides from atomic number 57 to atomic number 71.

10. The method of claim 1 performed at substantially room temperature.

11. The method of claim 3 wherein the plurality of substrates are substantially uniform in size and shape.

12. The method of claim 3 wherein the plurality of substrates vary in size and shape.

13. The method of claim 1 wherein the plurality of solid particles are dispersed in the liquid prior to providing the particles and liquid in the container.

14. The method of claim 13 wherein the particles comprise an alloy of the first and second elements.

15. A method of making pellets comprising:
providing a plurality of pelletized substrates in a container;
providing a plurality of particles comprising a metallic element in the container;
providing liquid mercury in the container; and
mechanically moving the container to effect the formation of a layer of material comprising an amalgam or composite of the metallic element and mercury on the surface of the substrates.

16. The method of claim 15 wherein the particles are dispersed in the liquid mercury prior to providing the particles and liquid mercury in the container.

17. The method of claim 15 wherein the particles have a maximum dimension not greater than 500 microns.

18. The method of claim 17 wherein the particles have a maximum dimension not greater than 50 microns.

19. The method of claim 18 wherein the particles have a maximum dimension not greater than 10 microns.

20. The method of claim 15 wherein the particles comprise zinc.

21. The method of claim 20 wherein the layer of material comprises Zn₃Hg.

22. The method of claim 21 wherein the layer of material comprises zinc amalgam, wherein the zinc amalgam is substantially all in the Zn₃Hg phase.

23. The method of claim 15 wherein the particles comprise bismuth.

24. The method of claim 15 wherein the particles comprise iron.

25. The method of claim 15 wherein the particles comprise tin.

26. The method of claim 15 wherein the layer of material comprises one-half to ninety weight percent mercury.

27. The method of claim 26 wherein the layer of material comprises forty to sixty weight percent mercury.

28. The method of claim 26 wherein the layer of material comprises one-half to twenty weight percent mercury.

29. The method of claim 15 wherein the layer of material comprises less than one-half weight percent mercury.

30. The method of claim 15 wherein the pellets comprise less than two weight percent substrate and more than ninety-eight weight percent layer of material.

31. The method of claim 15 wherein the pellets comprise between two weight percent substrate and ninety-eight weight percent substrate.

32. The method of claim 15 wherein the substrates comprise pellets formed by rapid quenching of a molten mixture of the metallic element and mercury.

33. A method of making pellets comprising:
providing a substrate to form the core of the pellet; and
mechanically plating an amalgam or composite layer encapsulating the core to form the outer surface of the pellet.

34. The method of claim 33 wherein the encapsulating layer includes a selected mercury content that may vary between one-half weight percent and ninety weight percent.

35. The method of claim 33 wherein the core comprises less than two weight percent of the pellet.

36. The method of claim 33 wherein the core comprises between two weight percent and ninety-eight weight percent of the pellet.

37. The method of claim 36 wherein the core comprises between ten weight percent and thirty weight percent of the pellet.

38. The method of claim 33 wherein the core comprises a material selected from the group consisting of glass, ceramic, metal, alloy, amalgam, cermet, plastic, and intermetallic compound, semiconductor.

39. The method of claim 38 wherein the encapsulating layer comprises one or more materials selected from the group consisting of zinc, tin, bismuth, indium, nickel, manganese, titanium, copper, iron, scandium, yttrium, and the lanthanides from atomic number 57 to atomic number 71.

40. The method of claim 33 wherein the encapsulating layer comprises a material selected from the group consisting of zinc, tin, bismuth, indium, nickel, manganese, titanium, copper, iron, scandium, yttrium, and the lanthanides from atomic number 57 to atomic number 71.

41. The method of claim 33 further comprising coating the core with a layer comprising a material selected from the group consisting of zinc amalgam, graphite, a plateable metal, and an alloy prior to mechanically plating the amalgam layer around the core.

42. A pellet comprising an inner core and a mechanically plated amalgam or composite material layer encapsulating the core to form the outer surface of the pellet.

43. The pellet of claim 42 wherein the encapsulating layer includes a selected mercury content that may vary between one-half weight percent and ninety-five weight percent.

44. The pellet of claim 42 wherein the core comprises less than two weight percent of the pellet.

45. The pellet of claim 42 wherein the core comprises between two weight percent and ninety-eight weight percent of the pellet.

46. The pellet of claim 45 wherein the core comprises between ten weight percent and thirty weight percent of the pellet.

47. The pellet of claim 42 wherein the core comprises a material selected from the group consisting of glass, ceramic, metal, alloy, amalgam, cermet, plastic, and intermetallic compound, semiconductor.

48. The pellet of claim 47 wherein said encapsulating layer comprises a material selected from the group consisting of zinc, tin, bismuth, indium, nickel, manganese, titanium, copper, iron, scandium, yttrium, and the lanthanides from atomic number 57 to atomic number 71.

49. The pellet of claim 42 wherein said encapsulating layer comprises a material selected from the group consisting of zinc, tin, bismuth, indium, nickel, manganese, titanium, copper, iron, scandium, yttrium, and the lanthanides from atomic number 57 to atomic number 71.

50. The pellet of claim 49 wherein said encapsulating layer further comprises glass or ceramic material.

51. The pellet of claim 42 further comprising layer of layer intermediate said core and said mechanically plated amalgam layer, said intermediate layer comprising a material selected from the group consisting of zinc amalgam, graphite, a plateable metal, and an alloy prior to mechanically plating the amalgam layer around the core.

52. The pellet of claim 42 wherein the largest dimension of said core is between 50 microns and 5000 microns.

53. The pellet of claim 42 wherein the largest dimension of said core is between 300 microns and 3000 microns.

54. The pellet of claim 42 wherein the thickness of the encapsulating layer is between 5 microns and 3000 microns.

55. The pellet of claim 54 wherein the thickness of the encapsulating layer is between 20 microns and 1000 microns.

56. The pellet of claim 42 further comprising a getter material.

57. The pellet of claim 42 wherein said encapsulating layer comprises bismuth and zinc.

58. The pellet of claim 42 wherein said encapsulating layer comprises iron and zinc.

59. The pellet of claim 42 wherein said encapsulating layer consists essentially of bismuth and mercury.

60. The pellet of claim 42 wherein said amalgam layer comprises element combinations selected from the group consisting of zinc-titanium-mercury, zinc-manganese-mercury, and bismuth-titanium-mercury.

61. A pellet comprising an outer layer of zinc amalgam wherein said zinc amalgam is substantially all in the Zn₃Hg phase and is formed at substantially room temperature.

62. A pellet comprising a core and a mechanically plated layer encapsulating said core and forming the outer surface of said pellet, said mechanically plated layer comprising one or more materials selected from the group consisting of zinc, tin, bismuth, iron, scandium, yttrium, indium, lead, gallium, cadmium, silver, copper, gold, aluminum, thallium, titanium, zirconium, manganese, nickel, chromium, cobalt, molybdenum, tungsten, alkali metals, alkaline earth metals, and the lanthanides from atomic number 57 to atomic number 71.

63. The pellet of claim 62 wherein said mechanically plated layer further comprises an inert material.

64. The pellet of claim 63 wherein said inert material comprises glass or ceramic material.

65. A pellet comprising an inner core and a mechanically plated layer encapsulating said core, said layer comprising mercury and another material in a metastable, non-equilibrium state.

66. The pellet of claim 65 wherein said encapsulating layer comprises one or more of zinc, tin, or bismuth.

67. The pellet of claim 65 wherein said mechanically plated layer is a first mechanically plated layer, and said pellet further comprises a second mechanically plated layer encapsulating said first mechanically plated layer, said second mechanically plated layer comprising mercury and another material in a metastable, non-equilibrium state, wherein said first and second mechanically plated layers have different compositions.

68. A material for use in mechanically plating substrates with an amalgam layer, said material comprising a powder of one or more metals dispersed in liquid mercury.

69. The material of claim 68 wherein said powder particles have a largest dimension between one microns and one hundred microns.

70. The material of claim 68 wherein said powder particles are substantially uniform in size.

71. The material of claim 68 wherein a portion of said powder particles are a first size and the remaining powder particles are a second size.

72. The material of claim 68 wherein said powder particles include particles in at least three different sizes.

73. The material of claim 68 wherein said powder particles are spherical.

74. The material of claim 68 wherein said powder includes one or more materials from the group consisting of zinc, tin, bismuth, indium, nickel, manganese, titanium, copper, iron, scandium, yttrium, and the lanthanides from atomic number 57 to atomic number 71.

75. The material of claim 68 further comprising glass powder dispersed in said liquid mercury.

76. The material of claim 75 wherein said glass powder comprises spheres having a diameter between one microns and one hundred microns.
